(19) United States
(12) Patent Application Publication
(10) Pub. No.: US 2009/0117308 A1
(43) Pub. Date: May 7, 2009

(54) APPARATUS AND METHOD FOR NOTATING MOVES, EVENTS, AND SCORING IN ACCORDANCE WITH RELIGIOUS CUSTOMS AND RESTRICTIONS

(76) Inventor: Donna Reis, Rye, NY (US)

Correspondence Address: CANTOR COLBURN, LLP, 20 Church Street, 22nd Floor, Hartford, CT, 06103, US

(21) Appl. No.: 11/936,333

(22) Filed: Nov. 7, 2007

(51) Int. Cl. B32B 33/00; B32B 37/00

(52) U.S. Cl. 428/41.8; 156/249

(57) ABSTRACT

An apparatus for notating moves, events, and scoring in accordance with religious customs and restrictions, the apparatus includes: a series of notation pads serving as attachment backing surfaces for a series of preprinted indicia; wherein the preprinted indicia are secured to the attachment backing surfaces in a removable, reusable, and non-permanent manner.

### BACKGROUND OF THE INVENTION

1. Field of the Invention

This invention relates generally to a notation pad and, more particularly, to an apparatus and method for notating moves, events, and scoring in accordance with religious customs and restrictions.

2. Description of the Related Art

Some religious customs, such as, for example, Jewish customs, generally forbid doing work on the Sabbath and certain religious holidays. The proscription of work extends from controlling electrical equipment, electronics, and appliances, operating automobiles, certain types of food preparation, to writing and creating permanent records of events, including picture taking. However, individuals who observe the Sabbath and other religious holidays often have a need to interact and compete with individuals who are not governed by their religious restrictions on the Sabbath. For example, gaming competitions, such as chess may be held on the Sabbath.

Chess competitions are generally timed events, with individual players allotted thirty to forty five minutes to complete their moves during a game. In addition, chess players are required to record or notate their chess piece moves, generally in a handwritten fashion in a spiral bound notebook. If an individual is unable to notate their chess moves, either due to a religious restriction, such as Sabbath observance, or a physical handicap, they are issued a time penalty. The time penalty is usually greater than the time required for performing the notation of the chess moves. A typical time penalty may be ten minutes, which is substantial in a timed event of only thirty to forty five minutes. Therefore, there is a need for an apparatus and method for notating moves, events, and scoring in accordance with religious customs and restrictions.

### SUMMARY OF THE INVENTION

Embodiments of the present invention include an apparatus and method for notating moves, events, and scoring in accordance with religious customs and restrictions, wherein the apparatus includes: a series of notation pads serving as attachment backing surfaces for a series of preprinted indicia; and wherein the preprinted indicia are secured to the attachment backing surfaces in a removable, reusable, and non-permanent manner.

A method for notating moves, events, and scoring in a chess match in accordance with religious customs and restrictions, wherein the method includes: removing preprinted indicia that are secured to the attachment backing surfaces of a notation pad in a removable, reusable, and non-permanent manner; arranging the preprinted indicia within a notation area on the notation pad in accordance with the chess move to be notated; wherein the arranging of the preprinted indicia within the notation area is done in a removable, reusable, and non-permanent manner; wherein the notation pads have areas designated for individual players and rounds of the chess match; and wherein the preprinted indicia have symbols or letters that represent chess pieces, as well as letters and numbers, whose combinations represent various positions on the chess board.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for an apparatus and method for notating moves, events, and scoring in accordance with religious customs and restrictions.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1B illustrates a series of notation pads according to an embodiment of the invention.

FIG. 2 illustrates indicia with human readable and machine-readable barcodes according to an embodiment of the invention.

FIG. 3 illustrates a clear plastic sleeve for holding the indicia according to an embodiment of the invention.

FIGS. 4A-4C illustrate a snap fit configuration for securing the indicia according to an embodiment of the invention.

The detailed description explains the preferred embodiments of the invention, together with advantages and features, by way of example with reference to the drawings.

### DETAILED DESCRIPTION

Embodiments of the invention provide an apparatus and method for notating moves, events, and scoring in accordance with religious customs and restrictions. Embodiments of the invention utilize preprinted indicia that are secured to a backing surface in a removable, reusable, and non-permanent manner. The preprinted indicia may be configured for the application in question, such as a chess match or a baseball game. For example, in an embodiment of the invention, the symbols or letters that represent chess pieces can be preprinted, as well as the letters and numbers, whose combinations represent various positions on the chess board. The preprinted indicia for chess play eliminate the need for hand writing to notate moves, events, and scoring, for individuals who are unable to write either due to religious or physical limitations. The removable, reusable, and non-permanent manner of attachment of the preprinted indicia fulfills the requirement of not creating anything permanent on the Sabbath.

An additional benefit of the preprinted indicia is to assist individuals with poor handwriting. Frequently, young children and adults with dysgraphia, a neurological condition leading to illegible and messy handwriting, avoid notation of their chess moves and suffer a penalty. In addition to suffering the formal penalty, the chess players are unable to support their argument in a disputed move or game. Without notation of their moves, the chess players are at a disadvantage because they cannot later review their games, and learn from their mistakes. Chess enthusiasts and tournament players to review their games with a parent, teacher, or chess coach commonly use computer analysis programs, for which notation is an essential input.

Embodiments of the preprinted indicia that are secured to a backing surface in a removable, reusable, and non-permanent manner may be formed from reusable stickers, or thin pieces of die-cut vinyl that are attracted to an electrostatic coating on the backing surface, such as employed by Colorforms™. In an alternative embodiment, Velcro™ can be utilized to attach the indicia. Velcro refers to an attachment method where hook and loop materials are used to secure opposing pieces for attachment. In further embodiments of the invention, the joining of the indicia to the backing, may be accomplished with plastic or metal interference or snap fits, or inserting the indicia into clear plastic sleeves.

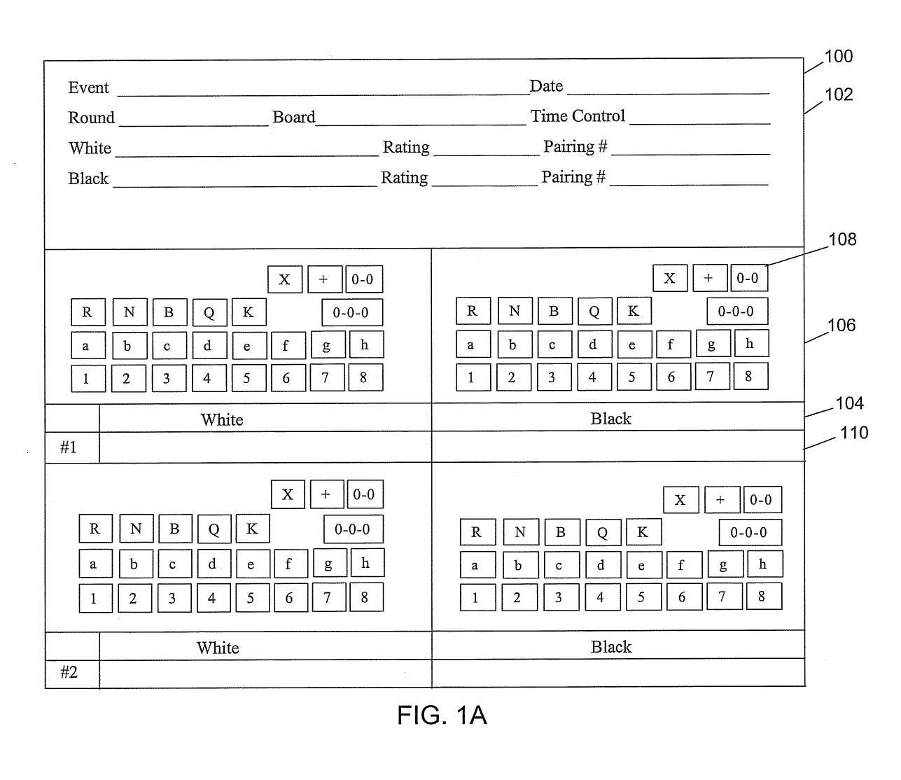

FIGS. 1A and 1B illustrate an embodiment of the invention as a series of notation pads 100 and 120 for chess play, respectively. The notation pads 100 and 120 have an electrostatic coating for precut preprinted vinyl indicia 108, or Velcro material on their surface (either hooks or loops depending on the backs of the preprinted indicia 108), and serve as the backing for the preprinted indicia 108. An individual that is not restricted by their religious beliefs, or by a handicap may fill out the header section 102 of the notation pad 100. Area 104 identifies the round of the chess match, and the player based on the color of their chess pieces, which are generally white and black. Area 106 contains the preprinted indicia 108. The user notates their move for the given round by removing the required preprinted indicia 108, and placing the removed indicia in the notation area 110 to record their move. A series of notation pads 120 are used until the chess match concludes, with the rounds numbered in order. The notation pads 110 and 120 may be bound or stored in a binding following their use.

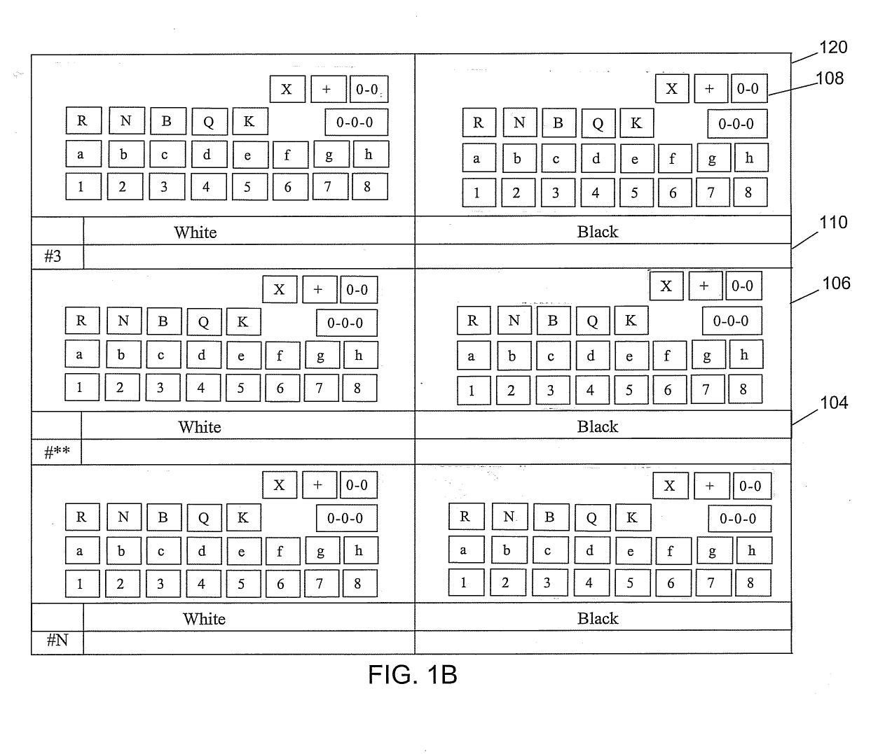

In a further embodiment of the invention, preprinted indicia 208 can be coded with barcodes 200, for example, as well as human readable characters 202 to facilitate input of chess piece moves into computer analysis programs, as illustrated in FIG. 2 for indicia representing the chess pieces.

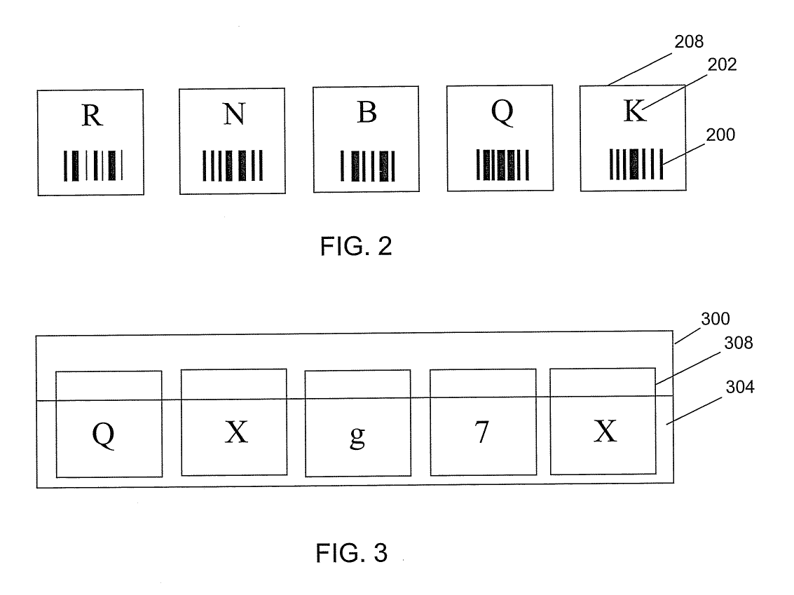

FIG. 3 illustrates an embodiment of the invention where preprinted indicia 308 are place in a sleeve mount 300 with a clear plastic overlay 304. Sleeve mounts with clear plastic overlays are commonly found in stamp albums, and have proven effective in holding their contents in order. A series of sleeve mounts 300 may be placed in the notation areas 110 of FIGS. 1A and 1B, to hold the preprinted indicia 108. In yet another embodiment, the indicia 308 can also be held in a series of sleeve mounts 300, prior to their placement in the notation area 110 sleeve mount 300.

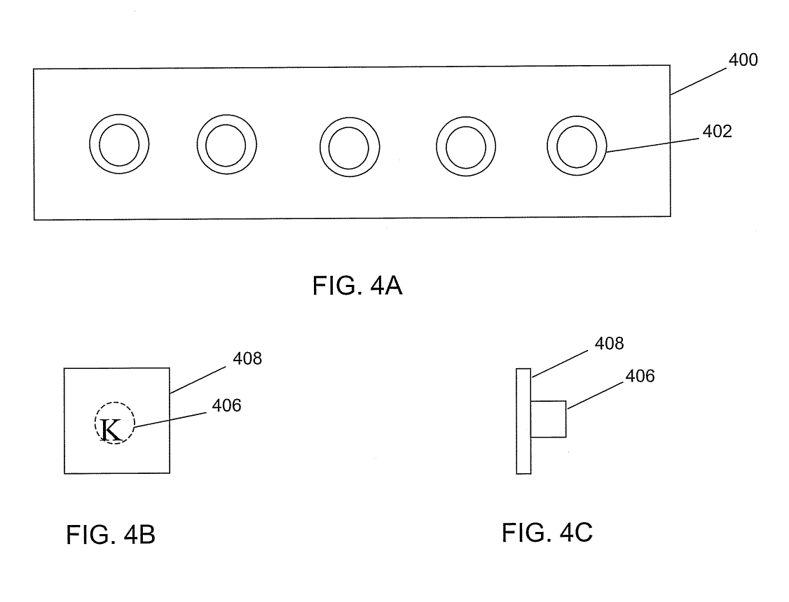

FIGS. 4A-4C illustrate an embodiment of the invention where the joining of the indicia to the backing may be accomplished with plastic or metal interference or snap fits. In this embodiment, notation areas 110 of FIGS. 1A and 1B are represented by a strip 400 of female snap receptacles 402 (see FIG. 4A), that mate with the male snaps 406 that are attached to the preprinted indicia 408, as seen in a front elevation view of FIG. 4B, and a side elevation view of FIG. 4C.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An apparatus for notating moves, events, and scoring in accordance with religious customs and restrictions, wherein the apparatus comprises a series of notation pads serving as attachment backing surfaces for a series of preprinted indicia; and
wherein the preprinted indicia are secured to the attachment backing surfaces in a removable, reusable, and non-permanent manner.

2. The apparatus of claim 1, wherein in the notation pads and preprinted indicia are configured according to their application; and
wherein the notation pads have graphics and are organized for the placement of the preprinted indicia.

3. The apparatus of claim 1, wherein the preprinted indicia are reusable stickers.

4. The apparatus of claim 1, wherein the preprinted indicia are thin pieces of die-cut vinyl that are attracted to an electrostatic coating on the attachment-backing surface of the notation pads.

5. The apparatus of claim 1, wherein Velcro™ joins the preprinted indicia to the attachment backings.

6. The apparatus of claim 1, wherein the notation pads have a series of clear plastic sleeves for holding the preprinted indicia.

7. The apparatus of claim 1, wherein the notation pads are joined to the preprinted indicia with plastic or metal interference snaps.

8. The apparatus of claim 1, wherein the preprinted indicia are coded to facilitate scanning into a computer.

9. The apparatus of claim 8, wherein the preprinted indicia have barcodes.

10. The apparatus of claim 1, wherein the notation pads can be bound.

11. The apparatus of claim 1, wherein the notation pads and preprinted indicia are configured for notating and tracking chess matches;
wherein the notation pads have areas designated for individual players and rounds of a chess match; and
wherein the preprinted indicia have symbols or letters that represent chess pieces, as well as letters and numbers, whose combinations represent various positions on the chess board.

12. The apparatus of claim 11, wherein in the preprinted indicia are coded to facilitate scanning into a computer.

13. The apparatus of claim 11, wherein the preprinted indicia have barcodes.

14. An apparatus configured for notating moves, events, and scoring in a chess match in accordance with religious customs and restrictions, wherein the apparatus comprises a series of notation pads serving as attachment backing surfaces for a series of preprinted indicia;
wherein the preprinted indicia are secured to the attachment backing surfaces in a removable, reusable, and non-permanent manner;
wherein the notation pads have areas designated for individual players and rounds of the chess match; and
wherein the preprinted indicia have symbols or letters that represent chess pieces, as well as letters and numbers, whose combinations represent various positions on the chess board.

15. The apparatus of claim 14, wherein the preprinted indicia are reusable stickers.

16. The apparatus of claim 14, wherein the preprinted indicia are pieces of die-cut vinyl that are attracted to an electrostatic coating on the attachment-backing surface of the notation pads.

17. The apparatus of claim 14, wherein the preprinted indicia are secured to the notation pads with at least one of the following: Velcro™, plastic sleeves, plastic interference snaps, and metal interference snaps.

18. The apparatus of claim 14, wherein the preprinted indicia are coded to facilitate scanning into a computer.

19. The apparatus of claim 14, wherein the preprinted indicia have barcodes to facilitate scanning into a computer.

20. A method for notating moves, events, and scoring in a chess match in accordance with religious customs and restrictions, wherein the method comprises:
removing preprinted indicia that are secured to the attachment backing surfaces of a notation pad in a removable, reusable, and non-permanent manner;
arranging the preprinted indicia within a notation area on the notation pad in accordance with the chess move to be notated;
wherein the arranging of the preprinted indicia within the notation area is done in a removable, reusable, and non-permanent manner;
wherein the notation pads have areas designated for individual players and rounds of the chess match; and
wherein the preprinted indicia have symbols or letters that represent chess pieces, as well as letters and numbers, whose combinations represent various positions on the chess board.
